(19) United States
(12) Patent Application Publication
(10) Pub. No.: US 2026/0251964 A1
(43) Pub. Date: Aug. 27, 2026

(54) GAME CAMERA STAND SYSTEM

(71) Applicant: Ben Sharp, Millsap, TX (US)

(72) Inventor: Ben Sharp, Millsap, TX (US)

(21) Appl. No.: 19/066,126

(22) Filed: Feb. 27, 2025

(51) Int. Cl. G03B 17/56; H02S 20/10

(52) U.S. Cl. CPC G03B 17/561; H02S 20/10; G03B 2217/007

(57) ABSTRACT

A stand system for the mounting of a camera thereupon, the stand system comprising a first stand section, the first stand section being capable of being placed at least partially into the ground, such that it cannot easily be moved, a camera mounting section operably connected to the first stand section, the camera mounting section capable of holding a camera, and optionally one or more additional stand sections that are operably connected between the first stand section and the camera mounting section.

### CROSS-REFERENCE TO RELATED APPLICATIONS

This application is not related to any other application.

### BACKGROUND OF THE INVENTION

The invention of small game cameras was a boon to anyone who needs to have long-term observations at a remote location. Such cameras typically feature a motion-activated camera, a memory card for the photos or videos, a battery that will last for days or weeks, and optionally cellular capabilities and/or solar power. Such cameras are useful to hunters who wish to see the number, quality, and type of game in a given area. They are also useful to ranchers who wish to keep a remote eye on their herds and watch out for predators or thieves. They are also useful to those that just want to see what kind of wildlife are in a given area.

Since the creation of game cameras, they have had some inherent issues. The first is that they must be mounted in an upright position. They also must be mounted in a place that the installer can reach. Given the remoteness of most preferred camera locations, most cameras end up typically attached to a tree, usually by a strap, at a height that the installer can reach without a ladder. The use of a tree as a mounting location then often requires the removal of branches, to create a clear field of view. One may also mount the camera to some other easily reachable vertical structure, such as a fence post.

The problem becomes, other actors can then also easily access the camera. Thereby, these other actors can steal the camera, remove the memory card, or otherwise damage it.

A typical camera stand is far too flimsy, and is easily intentionally knocked down by a trespasser, as well as accidentally knocked down by animals such as deer or cattle. Such animals are also naturally curious, and will lick or chew on the camera if it is within reach.

Further, being limited in height has other issues. One, a lower height limits the range of view. Second, the waving of longer grass or crops, blowing in the wind, can often trigger the camera, chewing up memory space and creating hundreds of empty pictures the camera operator has to sort through to find what they really want to see. Third, as many game cameras nowadays include cellular connections, a lower position, especially right next to a tree, can limit the range of cellular connection. Fourth, when the camera is in a tree, the waving of branches in the wind also caused the camera to take hundreds of empty pictures. And finally, being in the shade of a tree limits the camera's ability to use a solar cell to help recharge the camera or power the cellular system.

What is needed is a game camera mounting system that is easily transportable and can be erected easily by one person, the mounting system moving the camera position much higher up and preferably away from trees, to keep it away from bad actors, give a better view, improved cellular reception, and improved solar insolation, while also being able to withstand being easily knocked down or moved.

### SUMMARY OF THE INVENTION

Disclosed is a stand system for the mounting of a camera thereupon, the stand system comprising a first stand section, the first stand section being capable of being placed at least partially into the ground, such that it cannot easily be moved, a camera mounting section operably connected to the first stand section, the camera mounting section capable of holding a camera, and, optionally one or more additional stand sections that are operably connected between the first stand section and the camera mounting section. The stand system may further comprise one or more couplers, each coupler placed such that it aids in interconnecting two adjoining sections. Each coupler may fit on the outside of both of the adjoining sections it is connecting together. Each coupler may fit on the inside of both of the adjoining sections it is connecting together. The camera mounting section may be angled such that the camera is angled downward from the horizontal, in a range from 5 to 45 degrees. The width of each of the sections may be approximately the same. The widths of each sequential section may alternate between two widths. At least one of the connections between two adjoining sections may be maintained by use of a pin that passed through both sections. The pin may be a locking pin. Each coupler may be permanently affixed on one end of a section. All the sections are preferably sized so that they can be easily transported and handled. The length of the sections are preferably in the range of 2-4 feet. The sections and any couplers may be manufactured from square pipe or round pipe. The sections may be manufactured out of steel, aluminum, or composite materials. The camera mounting section may include a solar cell and a cellular antenna.

### BRIEF DESCRIPTION OF THE DRAWINGS

FIG. 1 is a side elevation view of a preferred embodiment of the stand system of the subject invention.

FIG. 2 is a side elevation view of another preferred embodiment of the stand system of the subject invention.

### DESCRIPTION OF ILLUSTRATIVE EMBODIMENTS

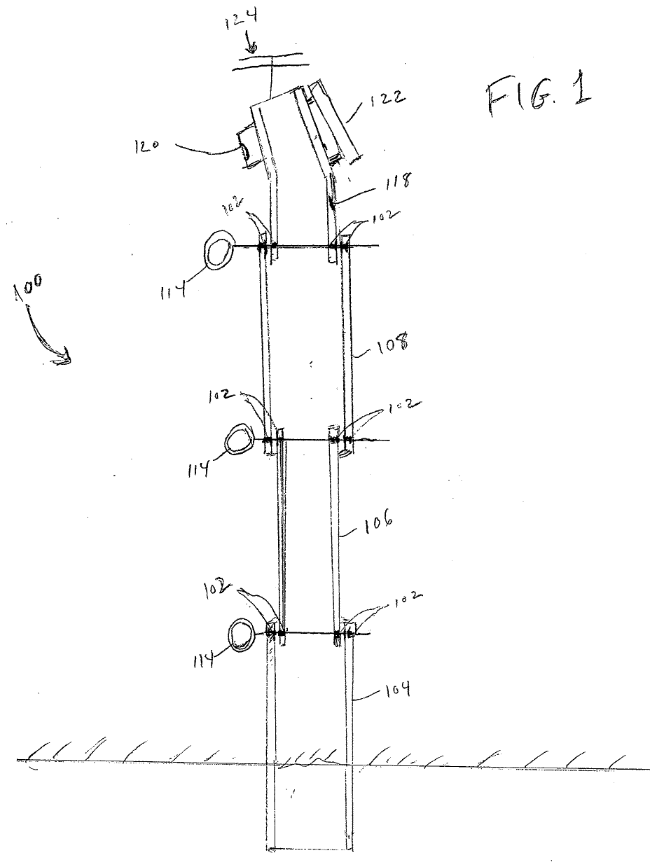

Referring now to FIG. 1, another preferred embodiment of the inventive camera stand system 100 is shown. A first stand section 104 is placed and then driven vertically into the ground. This section, like most or all of the subsequent sections, may preferably be made of steel or aluminum. It may be of a round or, preferably, square, cross-section. Its width may be a variety of sizes, preferably in the range of 1.5″ to 3″, with 2.5″ being most preferable. The gauge of the metal is preferably in the range of 18 to 11. The first stand section 104 can be driven into the ground using methods typical for such work, such as a fence post driver, or a sledgehammer and a piece of thick wood. The first stand section 104 is driven into the ground sufficiently that it is rigid and cannot be moved readily. Typically this may require a depth of over one foot. The installer would preferably situate the first stand section in a location providing the to-be-completed stand with a broad view, typically away from trees, houses or anything else that might obstruct the view, or the performance of the equipment mounted thereon. Once in place, the first stand section will cause the entire stand system 200 to be upright, rigid, and very difficult to move.

In this embodiment, above the first stand section 104 are additional stand sections 106 and 108. Any number of stand sections may be used, including none. Each stand section is of an alternating width, thus allowing adjoining section to have one section slide inside the other, with each additional stand section being approximately the same length as the first stand section. Thus, for example, section 108 is the same as section 104, and section 106 is the same diameter as camera mounting section 118, discussed infra. There are multiple benefits to breaking the stand up into multiple complementary sections. The installer only has to handle smaller pieces of metal, instead of trying to manhandle upright and into place a 10-12′ heavy metal tubular stand. For example, the sections could have a length in the 2′-4′ range. Likewise, when transporting the stand, having it broken down into several easy-to-assemble sections allows a single person driving most types of vehicles the ability to load, deliver and unload it without undue strain or effort, or having to worry about having a long piece of metal hanging awkwardly out from or off of their vehicle. Even if the preferred camera location is inaccessible by truck, jeep or four-wheeler, the stand may be packed in, either in multiple trips by one person, or one trip by multiple people. An individual backpacker might be able to carry in a complete aluminum version of the stand 100. Additionally, the purchaser of a stand can decide how many sections they want to use, to thus end up at a particular height, and purchase just what they need. If a section somehow gets damaged, one would need only to purchase a new section, not an entire new stand. Further, to change the height of an existing stand 100, one need only add two additional sections, one the wider size and one the smaller size, or, remove two adjoining sections.

In this particular embodiment of the stand 100, each section has a matched sets of holes 102 on opposite sides of the section, close to both ends of each section. To connect two sections together, the smaller diameter section is inserted into the larger diameter section, to a sufficient depth that the holes of one section align with the holes of the next section. Once in position, a pin 114 is passed through the aligned holes 102 in both sections, to thereby create a firm interlocking structure. The pin is preferable a locking pin, so a bad actor cannot easily remove the pin.

Regardless of how many stand sections are used, at the very top of the stand will be a camera mounting section 118. The camera mounting section is sized at its lower end so that it can appropriately interconnect with the highest of the stand sections, and will preferably be of the smaller diameter. The camera mounting section holds a camera 120. In this preferred embodiment, the camera mounting section is angled to create a non-vertical mounting surface. This is done so that the camera is aimed slightly more downward to see both what is immediately before it as well as to see at some distance, as opposed to just looking off to the horizon. It has also been found that by aiming the camera slightly downward, the motion of any nearby trees or long grass is less likely to cause the camera to start taking empty pictures or videos. The angle is preferably in the range of 5 -45 degrees downward from horizontal, most preferably around 10 degrees.

The camera 120 can be any game camera, as they almost universally have a standard mounting system, and thus the camera mounting section will have an appropriate receiver to connect to the camera.

Also shown in FIG. 1 are two optional items that can be included with the camera mounting section. The first is a solar cell 122, which can be connected to the camera 120 to provide power to recharge the camera's batteries. Also shown is a cellular antenna 124, which may be used to enhance the distance and directionality of cellular signals for the camera 120. The benefits of both of these items are enhanced by the stand 100 being both tall and away from trees and structures.

The biggest benefit of this invention is that a single person can construct a tall, very sturdy, camera stand, by themselves. If one is able to bring at least a four-wheeler or other vehicle out to the preferred location for the stand, one can carry all they need to build it on site, quickly and easily. For instance, using the stand shown in FIG. 1, and sections around 3 feet in length, once the constructor arrives at the location, the first stand section 104 is aligned in the desired direction of camera view, and driven into the ground. The second stand section 106 is then set into the first stand section 104, and a pin 114 is slid through the aligned holed in both sections, connecting them together. Note that is when using square pipe has a major advantage over round pipe, as it is much simpler to align the holes.

The remaining sections can be added via two different methods. One, the remaining two sections can be added sequentially. That is, section 108 is set onto 106 and pinned, then the camera section 118 is added, assuming the person building the stand can reach that high. This allows the person to have to handle only the weight of a single section at a time. Alternately, the third stand section 108 can first be connected with the camera mounting section 118 while both are on the ground to create a subassembly, then the entire subassembly set up onto section 106. This method creates a greater weight to lift, set and pin, but it does not have to be raised as high. Regardless of which of these processes are used, the camera is prepped, started, and mounted on the camera mounting section 118 while on the ground and before it is raised to its full mounted height. If any optional equipment, such as a solar cell 122 or cellular antenna 124 are to be included in the stand, they are also added while the camera mounting section is still on the ground. Thus, the entire stand can be constructed in place by a single person with a minimal of tools, with the camera now far out of reach of people, and not movable by accidental damage or bumping, such as by cattle.

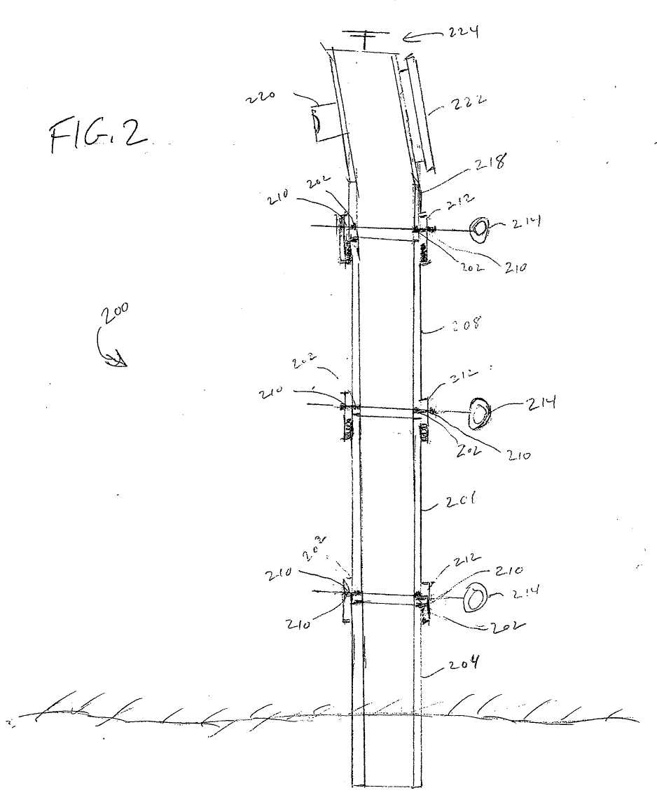

Referring now to FIG. 2, another preferred embodiment of the inventive camera stand system 200 is shown. As with the embodiment shown in FIG. 1, a first stand section 204 is placed and then driven vertically into the ground. In this embodiment, above the first stand section 204 are additional stand sections 206 and 208. While shown here with two additional stand sections, any number of additional stand sections may be used, including none, with each additional stand section being constructed the same as the first stand section. Each of stand sections 204, 206 and 208 have holes 202 at their lower ends.

In this particular embodiment of the stand 200, each section includes a coupler 212. Each coupler is preferably of a slightly larger width than the sections and partially overlaps with the upper end of each section. The coupler 212 is attached to the upper end of a section via welding or other traditional attachment methods. Each coupler also has a set of holes 210 in the portion not covering the upper end of the section to which it is attached. As each new section is added to the stand system 200, including the first stand section 204, the coupler 212 is in the upward position, and the holes 202 are in the downward direction. Each successively higher section is set down into the coupler of the lower section. Matching holes 202 and 210 are designed to align when an upper section is set down onto the lower section, with the lower end of the upper section abutting the upper end of the lower section. Once an upper section is set down into the coupler fully, the holes in the coupler and lower section will align, and a pin 214 may be passed through the all the holes and preferably locked. Using this stand system 200, all the sections can be identical, with the exception of the camera mounting section 218, discussed infra.

As with the embodiment of FIG. 1, a camera mounting section 218 is the final section added to the top of the stand system. The camera mounting section will include a camera 220, and optionally a solar cell 222 and a cellular antenna 224. The camera mounting section has holes 202 at its lower end so that it can appropriately interconnect with the holes 210 in the coupler of the highest of the stand sections. The camera mounting section holds a camera 220, and in this particular embodiment it also holds a solar cell 222 and a cellular antenna 224. In this preferred embodiment, the camera mounting section is angled to create a non-vertical mounting surface. The angle is preferably in the range of 5 -45 degrees downward from horizontal, most preferably around 10 degrees.

While described above as having the coupler welded to the upper end of a section, in fact it may be attached by any well-known method, including pins, threads, friction fit, etc., Another alternative embodiment would use couplers that are slightly narrower than the sections, and thus fitting on the inside of a section end instead of on the outside. Additionally, the couplers could be sold as separate parts, with holes in both ends of the coupler to connect in a system where each section also has holes in both ends.

One benefit of this particular embodiment is that one may purchase any number of stand sections, and not be restricted to just an even number, as compared with the embodiment shown in FIG. 1. An additional benefit is that it may prove easily to handle and align a new section by just dropping the new upper section into the coupler, with the ends of the lower section abutting and thus bearing the weight of the upper section while awaiting pinning. And, the holes for the coupler and the adjoining section will be aligned as by design, without the builder having to carefully hold the full weight of the section while trying to gauge how far up and down to move the upper section to align the holes.

While the preferred embodiments uses pins for the purpose of interconnection of the section, one could also use any other of the well-known methods of connecting pipe sections, such as matching flanges, threads, etc., and still be within the spirit of the invention.

And while steel is a preferred metal for the stand, one could also use aluminum, or any other material that has adequate stiffness and toughness, such as certain plastics or composite materials such as carbon fiber, and still be within the spirit of the invention.

All of the components and structures disclosed and claimed herein can be made and executed without undue experimentation in light of the present disclosure. While the components and structures of this invention have been described in terms of preferred embodiments, it will be apparent to those of skill in the art that variations may be applied to the components and structures and/or methods and in the steps or in the sequence of steps of the method described herein without departing from the concept, spirit and scope of the invention. More specifically, it will be apparent that certain materials and shapes which are related may be substituted for the materials and shapes described herein while the same or similar results would be achieved. All such similar substitutes and modifications apparent to those skilled in the art are deemed to be within the spirit, scope and concept of the invention as defined by the appended claims.

What is claimed is:

1. A stand system for the mounting of a camera thereupon, the stand system comprising:
a first stand section, the first stand section being capable of being placed at least partially into the ground, such that it cannot easily be moved;
a camera mounting section operably connected to the first stand section, the camera mounting section capable of holding a camera; and,
optionally one or more additional stand sections that are operably connected between the first stand section and the camera mounting section.

2. The stand system of claim 1, further comprising one or more couplers, each coupler placed such that it aids in interconnecting two adjoining sections.

3. The stand system of claim 1, wherein each coupler fits on the outside of both of the adjoining sections it is connecting together.

4. The stand system of claim 1, wherein each coupler fits on the inside of both of the adjoining sections it is connecting together.

5. The stand system of claim 1, wherein the camera mounting section is angled such that the camera is angled downward from the horizontal, in a range from 5 to 45 degrees.

6. The stand system of claim 2, wherein the width of each of the sections are approximately the same.

7. The stand system of claim 1, wherein the widths of each sequential section alternates between two widths.

8. The stand system of claim 1, wherein at least one of the connections between two adjoining sections is maintained by use of a pin that passed through both sections.

9. The stand system of claim 7, wherein the pin is a locking pin.

10. The stand section of claim 1, wherein each coupler is permanently affixed on one end of a section.

11. The stand system of claim 1, wherein all the sections are sized so that they can be easily transported and handled.

12. The stand system of claim 1, wherein the length of the sections are in the range of 2-4 feet.

13. The stand system of claim 1, wherein the sections are manufactured from square pipe.

14. The stand system of claim 1, wherein the sections are manufactured from round pipe.

15. The stand system of claim 12, wherein the couplers are manufactured from square pipe.

16. The stand system of claim 13, wherein the couplers are manufactured from round pipe.

17. The stand system of claim 1, wherein one or more sections are manufactured out of steel or aluminum.

18. The stand system of claim 1, wherein one or more sections are manufactured out of a composite material.

19. The stand system of claim 1, wherein the camera mounting section includes a solar cell.

20. The stand system of claim 2, wherein the camera mounting section includes a cellular antenna.
